(19) United States
(12) Patent Application Publication
(10) Pub. No.: US 2003/0134708 A1
(43) Pub. Date: Jul. 17, 2003

(54) Cyclo torque multipliers

(76) Inventor: Otto Regner, Troy, MI (US)

Correspondence Address: OTTO REGNER, 5491 WINCHESTER, TROY, MI, 48085, US

(21) Appl. No.: 10/042,626

(22) Filed: Jan. 11, 2002

(51) Int. Cl. F16H 1/32

(52) U.S. Cl. 475/178

(57) ABSTRACT

Geometric design arrangements and relations of cyclo gears fashioned to produce high mechanical rigidity, long life expectancy, and applicability. These designs incorporate bearing and hub-axis, hollow centers and hollow torque pins, especially with three disks and three cam cyclo gear arrangements. The previous performance limiting load vector influence is eliminated. These inventions simplify the building of machines, particularly when multiple cyclo gear axes are used in sequence, as in base turn tables and arm and wrist assembly clusters for robots and other tools. A true roll-up by maximum engagement of the cyclo components is guaranteed by employing the geometrical relations shown. Also included are 1) a schematic showing simplification of the absolute encoder system for servos in machine tools and robotics and 2) a circuit for an anti-oscillating add-on filter for servos in machine tools and robotics. Time spacing update limitations of many controls and the form plasticities of materials are being minimized and masked with these patent features.

### BACKGROUND OF THE INVENTION

Cyclo torque multipliers in machine tools, specifically robots, still fail prematurely today. Robots are still badly hampered by harmonic vibrations and insufficient rigidity. The life of many cyclo gears is short as is the case with machine tools, too.

FIGS. 1-5 drawings explain how, by the use of these geometric design arrangements and relations, a much higher mechanical rigidity, life expectancy, and applicability of cyclo gears is accomplished. These designs incorporate bearing and hub-axis, hollow centers and hollow torque pins, especially with three disks and three cam cyclo gear arrangements. These inventions simplify the building of machines, particularly when multiple axes are used in sequence, as in base turn tables and arm and wrist assembly clusters for robots and other tools. A true roll-up by maximum engagement of the cyclo components is guaranteed by employing the geometrical relations shown.

The FIG. 6 schematic shows the simplification of the absolute encoder system for servos in machine tools and robotics.

The FIG. 7 circuit is the smoothing, anti-oscillating add-on filter for servo systems in machine tools and robotics.

### BRIEF DESCRIPTION OF THE DRAWINGS

FIG. 1 invention drawings explain the basic geometrical relationship of the “cyclo-module” to the cyclo housing/roller cage, the cyclo wave disk, and the cam/eccentric dimensions. These geometrical design relations and the realized simplifications are the basic features of these inventions.

In FIG. 2, the basic cyclo torque multipliers are drawn with one, two, and three wave disks—shown in both front and cut views. The six drive-out pins kept in the drive-out flange within a capturing flange, bearing, and housing arrangement are improvements here. The cyclo torque multiplier with the three wave disks is new, and it is the least prone cyclo gear to load deflection. The two wave disk cyclo torque multiplier is somewhat open to outside load behavior. The least rigid and unbalanced cyclo torque multiplier has only one wave disk, and it is only recommended for miner low speed applications.

The circular relationship of cams and disks is given at 360 degrees divided by the numbers of the disks. For instance, 2 disks are 180 Degrees apart, and 3 disks are 120 degrees apart.

The FIG. 3 cyclo gear torque system has three camshafts, three wave disks, three through-mounted (hollow) torque rods, three planet gears, and one sun gear. This is the most accurate and responsive design arrangement in cyclo gears. The two main bearings support the drive-outs and act as axis bearings. Significantly new is that the input camshafts are in use for the drive-out torque force coupling, providing a play-free high torque connection and transfer. The cyclo gear is also a complete axis. Applying precision manufacturing tolerances, the response hysteresis of this design is practically zero. A zero backlash is relevant in many applications and this cyclo design fits this label.

In FIG. 4, the heavy-duty precision cyclo gear system is identical with the one in FIG. 3, except all components are stronger for heavy-duty application. It also includes one outer-center peripheral sun gear for a side-in drive and a space for a lead-through drive shaft, coaxial shafts, or a path-through cable.

In FIG. 5, a center-driven cyclo gear-axis is the economic cyclo axis system which uses compact needle-roller bearings for total compact design. The torque bars may also be made hollow for lead-through shafts, cables, etc. The centered cam-shaft may be maximized and additionally hollowed for coaxial shaft application.

In FIG. 6, the battery power-backed, transistor to transistor logic, two channel single rotation encoder system, replaces what is currently used (i.e., the costly two-scale counter encoder servo systems with two encoders, four channels, with one channel revolution counter and anti-backlash gear down-gearing system for absolute position encoding). With this new constantly “ON” low-powered battery-backed encoder system, the rotation position is always known after the original position calibration, even when the main power is off and disconnected, as long the battery is powering the encoder. The battery power should supply the encoder system for five years (per recommendation of this inventor). A low battery voltage system indicator and system disabler is incorporated for safe operation.

The schematics in FIG. 7 shows one add-on harmonic damping filter for analog electronic feedback loops. It is desirable to increase the life of components by reducing or eliminating harmonic vibrations. This filter is very easy to apply and very effective in improving life and performance of machine tools and cyclo gears. It filters and impedes vibration.

### DETAILED DESCRIPTION OF THE PREFERRED EMBODIMENT

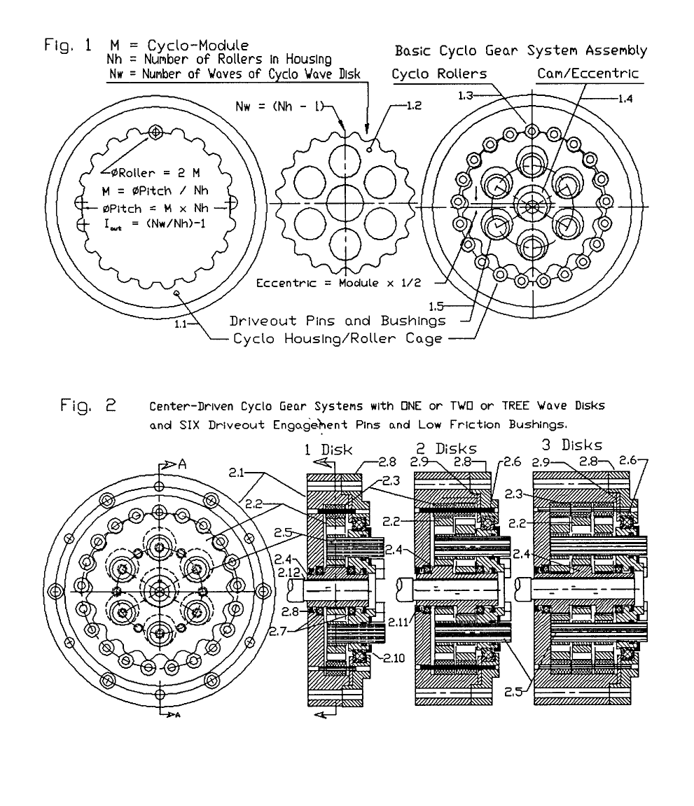

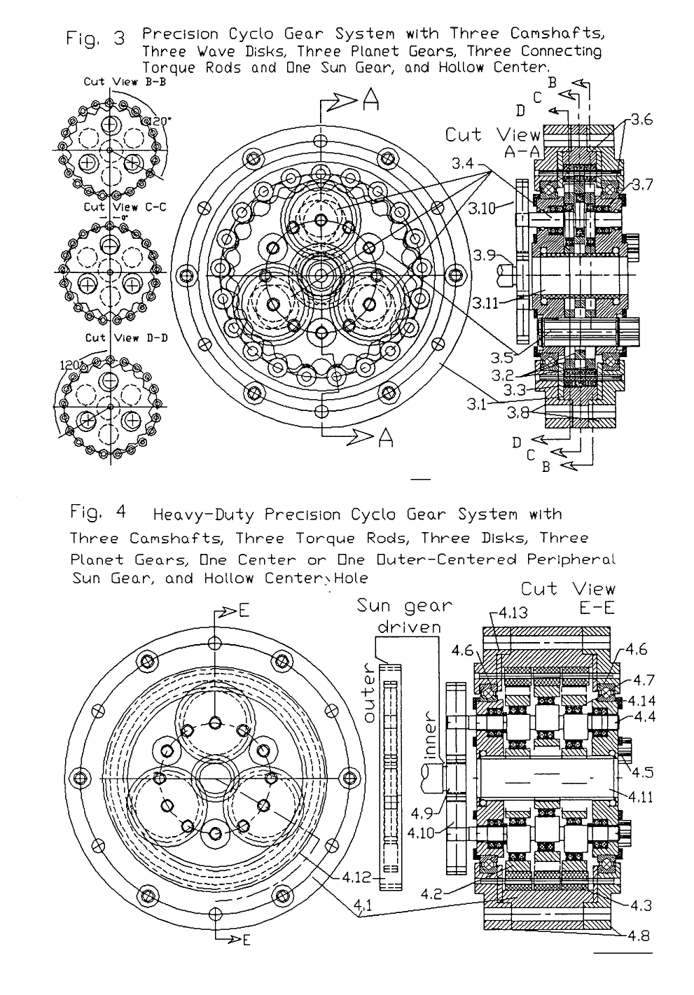

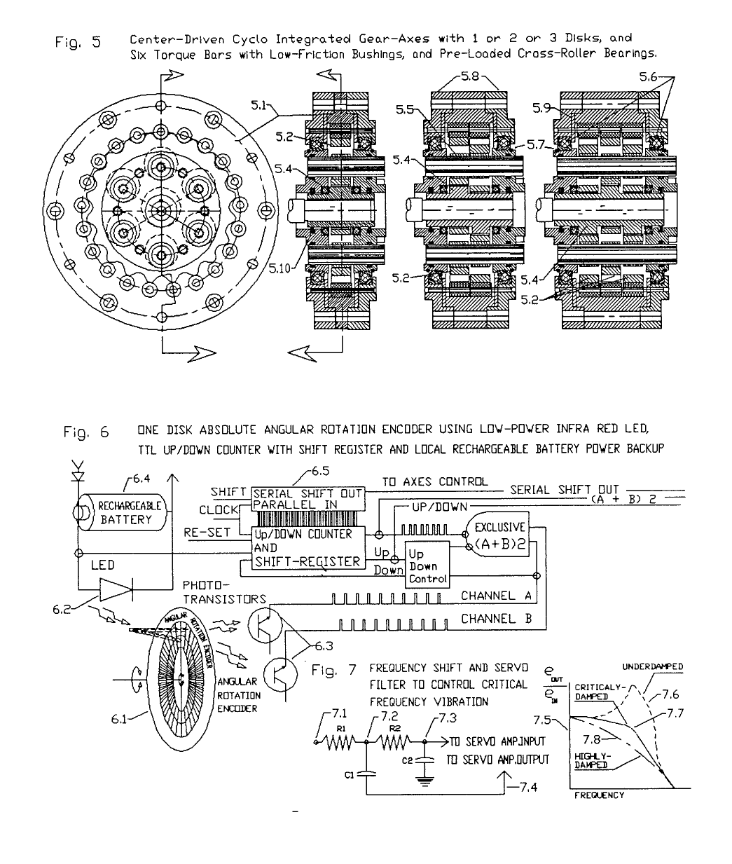

The invention cyclo torque multiplier, FIGS. 1-5, are mostly used in robotics manipulators, tooling, and production machines, etc., which are driven by electric or hydraulic servo motors for vibration-free movements, positioning, and indefinite programmed or adaptive positioning. FIGS. 6 and 7 apply to the servo control part in connection with the cyclo torque multipliers.

The basic geometrical relations are given in FIG. 1 along with the relations of the cyclo-module. The cyclo-module relates to the roller size and spacing, the diameter pitch, the roll-up dimension, the roller spacing, the cam offset size, and the cyclo wave disk dimensions.

In FIG. 1 (#1.1), the cyclo housing carries the slip-fitted rollers (#1.3). The wave disk(#1.2) is mounted concentric with bearings to the cam (#1.4). The high torque drive out is accomplished with the pins and bearing bushings (#1.5). The drive-out pins are press-fitted into the drive-out flange.

FIG. 2 shows the cantilevered pin drive-out cyclo torque multiplier assembly with one, two, and three wave disks (#2.2 cut views) and cam with bearings (#2.4). The drive-out pins are press-fitted into the drive-out flange (#2.10) that transmit the high torque generated by the crank's rotation. The cams do engage the wave disks with the rollers. The rigid center location of the cam shaft to the roller cage housing, the drive-out flange (#2.10), bearing (#2.6), sides housing (#2.8), and cycle housing/roller cage, is secured here.

FIG. 3. The precision cyclo gear system and torque multiplier assembly shows the drive-out pins (#3.5) do rigidly connect the two opposing drive-out flanges. The contained force generating by the input torque by way of one sun gear (#3.9), three planet gears (#3.10), and three cams (#3.4) rotate wave disks (#3.2) around counteracting rollers (#3.3) and the cyclo housing/roller cage (#3.1). The cams (#3.4) and wave disks (#3.2), by way of play free bearings, transmit the output torque to the high torque output flanges.

The output torque=0.98×1/i×input torque. These systems are very effective.

The hollow center (#3.11) make coaxial lead through possible. The three hollow drive-out pins (#3.5) allow the lead through of cables, shafts, etc. Because of the two-bearing system, the radial and axial loads can be higher as in the loads of a cantilevered system. The rigidity of this system is so high that harmonic oscillation is eliminated. Or, if brought in by the input rotation, they are reduced by the total linear gear ratio of the system.

FIG. 4. This precision cyclo gear system is basically similar to the previous one shown under FIG. 3 except it is the heavy duty version of it. It also shows how a peripheral planetary sun gear may be used for driving it on with a timing belt, etc. The heavy duty cyclo gears may be used for turn tables, out-layer arms, etc. The easy use is accomplished because it is a backlash free cyclo gear axis with four lead through opportunities, one center (#4.11) and three hollow torque rods. When extremely high loads need handling, roller, and cross roller bearings (#4.6) will be incorporated.

FIG. 5. A most economic heavy duty cyclo torque axes with one center driven cam shaft (#5.4) and six hallow torque pins and needle bearings (#5.5) is the most compact and rigid. The axes bearings (#5.6) are deep-groove ball bearings. As with all the other cyclo gear torque multipliers, the three-wave disk (#5.2) system is the most vibration-free system. All shafts are sealed with lip-seals to allow semi-liquid lubrication for a long gear life.

FIG. 6. This schematics shows the invention of an inexpensive absolute rotating encoder or shaft encoder. With the rechargeable battery (#6.4) the LED (#6.2) generates a light beam. The angular rotation encoder (#6.1) has transparent circular windows that let the light path through or stop it. The light will trigger the photo-transistors (#6.3) ON and OFF, making square pulses in the channel A and B. If the Channel A pulse is leading, the up-counter is counting with increasing counts. If the Channel B pulse is leading, then the down-counter is decreasing the counts. The counts represent an axes or gear positions in machine tools, robots, etc. The shift register (#6.5) allows a computer, for instance, to access the counter data for position verification on start up, during calibration of the axes, etc. Because the battery recharges when the machine is powered and the counter is in use, the battery is powering the counter at all times. This arrangement constitutes an inexpensive absolute counter. This system reduces the absolute encoder cost by about 65%, and increases the absolute encoder reliability by a minimum of 300%, because of fewer components in use.

FIG. 7. This circuit is a smoothing, anti-oscillating add-on filter for servo systems. Inertia, imbalance, and manufactured imperfection, influence rotating shafts, gears, and machine elements. This imperfection quite often shows up as vibration and oscillation. Servo drives, because of the feedback, stimulate the vibration especially if the servo response is working in a high-gain mode. To minimize or eliminate this problem, the add-on-filter for servo systems was invented.

At the #7.1 node, the servo (correctional) signal enters into the amplifiers. The undamped signal becomes the underdamped signal at the next frequency cycle, and the under-damped (#7.6) curve increases to a saturation point. At node #7.2 (based on the R1, C1 time constant), a shift and an attenuation of the signal will occur. At node #7.3, the feedback signal (coupled by C1 and the R2, R1) is further damped. The damping curve (#7.7) is most desirable. The highly-damped curve (#7.8) is more easily tuned up than the curve (#7.7) for a more specific application.

I claim:

1. A geometrical design arrangement for planet type roller gear. The basic geometrical relationship of the “cyclo-module” to the cyclo housing/roller cage, the cyclo wave disk, and the cam/eccentric dimensions. These geometrical design relations and the realized simplifications are the basic features of these inventions.

2. A geometrical design arrangement for planet type roller gear according to claim 1 wherein: the roller cage has the given relation to the cyclo-module as shown in FIG. 1.

3. A geometrical design arrangement for planet type roller gears to claim 2: wherein the roller size has a geometrical relation to the cyclo module as indicated under FIG. 1.

4. A geometrical design arrangement for planet type roller gears according to claim 3: wherein the eccentric has a geometrical relation to the cyclo module and claim 3.

5. A geometrical design arrangement for planet type roller gear according to claim 4:
wherein the wave disk has a geometrical relation to claim 1-4.

6. A geometrical design arrangement for planet type roller gears according to claim 5: wherein three eccentrics are spaced equally between the center and the roller cage as shown in drawings FIGS. 3 and 4.

7. A geometrical design arrangement for planet type roller gears according to claim 6: wherein the number of cams are not limited to 1, 2, or 3, The Size of the cyclo assembly and cost will determine if more than three cams are practical.

8. A geometrical design arrangement for planet type roller gears according to claim 7: wherein the cams are spaced to drive out the high torque generated by the cyclo gears wave disk(s) in connection to the cam(s).

9. A geometrical design arrangement for planet type roller gears according to claim 8: wherein the two drive-out flanges are driven by the cams by play-free bearings (FIGS. 3,4).

10. A geometrical design arrangement for planet type roller gears according to claim 9: wherein flange and housing bearings form a unit axes-cyclo-gear-assembly (FIGS. 3,4,5).

11. A geometrical design arrangement for planet type roller gears according to claim 10: wherein a multitude of rods (torque, stabilizing bars), hallow or solid, stabilize and rigidities the two drive-out flanges as shown in FIGS. 3,4,5. to a coherent gear-driven axis assembly.

12. A geometrical design arrangement for planet type roller gears according to claim 11: wherein a single or pair of deep groove or a cross-roller bearing is used to stabilize the high torque flange to the gear housing, as in FIG. 2, to make the gear assembly an axis or turntable.

13. A geometrical design arrangement for planet type roller gears according to claim 12: wherein all hallow cyclo rollers are securely positioned with pins to the roller cage as shown in FIGS. 1-5.

14. A geometrical design arrangement for planet type roller gears according to claim 1 to 13: wherein position accuracy by the use of the cyclo gear assembly is further enhanced by controlling its position. To know the rotation position at any time by adding an absolute shaft encoder to the gear axis drive-in or drive-out, depending on the use of the cyclo gear drive/axis, as shown on FIG. 6. This is a very important and useful feature and a very worthwhile claim.

15. A geometrical design arrangement for planet type roller gears according to claim 14: wherein the absolute angular encoder, consisting of a permanently battery power backed “On” encoder up/down counter with accessible shift register/memory is added as shown in FIG. 5.

16. A geometrical design arrangement for planet type roller gears according to claim 15: wherein the analog summing circuits and feed-back servo circuit often feeds back data misdirecting the summing results and therefor the servo action. The FIG. 7 frequency and servo filter counteracts irrelevant signals and enhances further the productivity and performance of the cyclo torque multiplier and cyclo gear axis.
